(19) United States
(12) Patent Application Publication
(10) Pub. No.: US 2011/0151695 A1
(43) Pub. Date: Jun. 23, 2011

(54) Card Connector

(76) Inventor: Chih-Ling Yang, Taipei (TW)

(21) Appl. No.: 12/645,470

(22) Filed: Dec. 22, 2009

(51) Int. Cl. H01R 13/62

(52) U.S. Cl. 439/159

(57) ABSTRACT

A card connector has an insulating housing defining a top, a bottom opposite to the top. An ejection mechanism is disposed at one side of the insulating housing. The ejection mechanism includes a slider, an elastic element and a cam lever. Two opposite ends of the cam lever respectively have a first hook portion for being fixed in a receiving hole defined at the top of the insulating housing and a second hook portion for being movably arranged in the slider and different in length with the first hook portion. The bottom of the insulating housing defines an observation slot communicating with the receiving hole at a portion corresponding to the receiving hole. The height of the receiving hole is shorter than the length of one of the first and second hook portions and not shorter than the other of the first and second hook portions.

### BACKGROUND OF THE INVENTION

1. Field of the Invention

The present invention relates to a card connector, and more particularly to a card connector with an ejection mechanism.

2. The Related Art

A conventional card connector has an insulating housing, a shield, a plurality of conductive terminals and an ejection mechanism mounted in the insulating housing. The insulating housing has a receiving space for receiving an inserted card, and a sliding groove disposed at a side of the receiving space and communicating with the receiving space capable of receiving the ejection mechanism. The ejection mechanism has a slider and a cam lever. The slider defines a trace trough therein. The cam lever have two opposite ends respectively bent towards a same side to form a first hook portion and a second hook portion shorter than the first hook portion in length. The first hook portion is pivotally received in a receiving hole of the insulating housing, and the second hook portion is arranged in the trace trough, in assembly. Nevertheless, since the first hook portion and the second hook portion have a small difference in length, the cam lever is easily to be assembled in a reverse direction, that is, the second hook portion is inserted into the receiving hole and the first hook portion is disposed in the trace trough of the slider, which is less likely to be discovered and makes the second hook portion of the cam lever slide out of the receiving hole easily to interfere with the product performance in using.

### SUMMARY OF THE INVENTION

An object of the present invention is to provide a card connector adapted for receiving a card therein. The card connector has an insulating housing defining a top, a bottom opposite to the top. The top has a receiving space for receiving the inserted card. A plurality of conductive terminals is disposed in the insulating housing for contacting the card. An ejection mechanism of a push-push type is disposed at one side of the insulating housing for ejecting the card from the insulating housing. The ejection mechanism comprises a slider slidably mounted in the insulating housing along an insertion direction and an ejection direction opposite to the insertion direction, an elastic element for providing a push force to the slider along the ejection direction and a cam lever. Two opposite ends of the cam lever respectively are bent towards a same side to form a first hook portion for being fixed in a receiving hole defined at the top of the insulating housing and a second hook portion for being movably arranged in the slider and different in length with the first hook portion. The bottom of the insulating housing defines an observation slot communicating with the receiving hole at a portion corresponding to the receiving hole. The height of the receiving hole is shorter than the length of one of the first and second hook portions and not shorter than the other of the first and second hook portions. Whereby, in assembly of the cam lever, which of the first and second hook portion being inserted in the receiving hole can be recognized by observing if the free ends of the first and second hook portions are extended into the observation slot.

As described above, if the free ends of the first and second hook portions being extended into the observation slot can be observed to check the inserting direction of the cam lever, which will ensure the cam lever to be correctly assembled to the slider of the ejection mechanism and save the assembly time. So the card connector is excellent and can be used widely, and for a longer time.

### BRIEF DESCRIPTION OF THE DRAWINGS

The present invention will be apparent to those skilled in the art by reading the following description of a preferred embodiment thereof, with reference to the attached drawings, in which:

FIG. 1 is an assembled, perspective view of a card connector in accordance with the present invention;

FIG. 2 is an exploded, perspective view of the card connector shown in FIG. 1;

FIG. 3 is a perspective view of an insulating housing of the card connector shown in FIG. 2 seen from another direction;

FIG. 4 is a perspective view of the card connector shown in FIG. 1, wherein a card is inserted into the card connector and a shield of the card connector is cut partially;

FIG. 5 is a sectional view of the card connector showing a cam lever of the card connector shown in FIG. 2 is correctly assembled; and

FIG. 6 is a sectional view of the card connector showing the cam lever of the card connector shown in FIG. 2 is incorrectly assembled.

### DETAILED DESCRIPTION OF THE PREFERRED EMBODIMENT

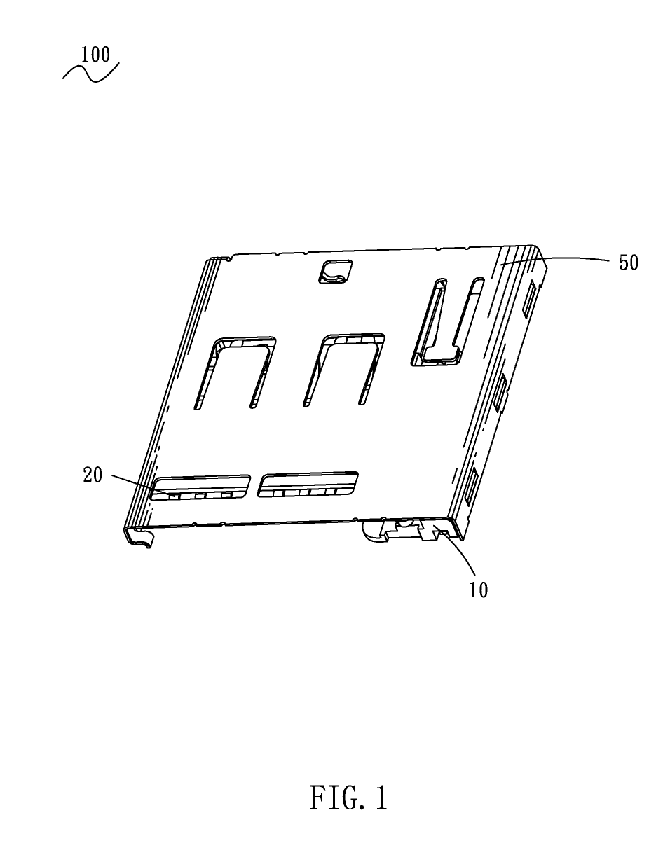

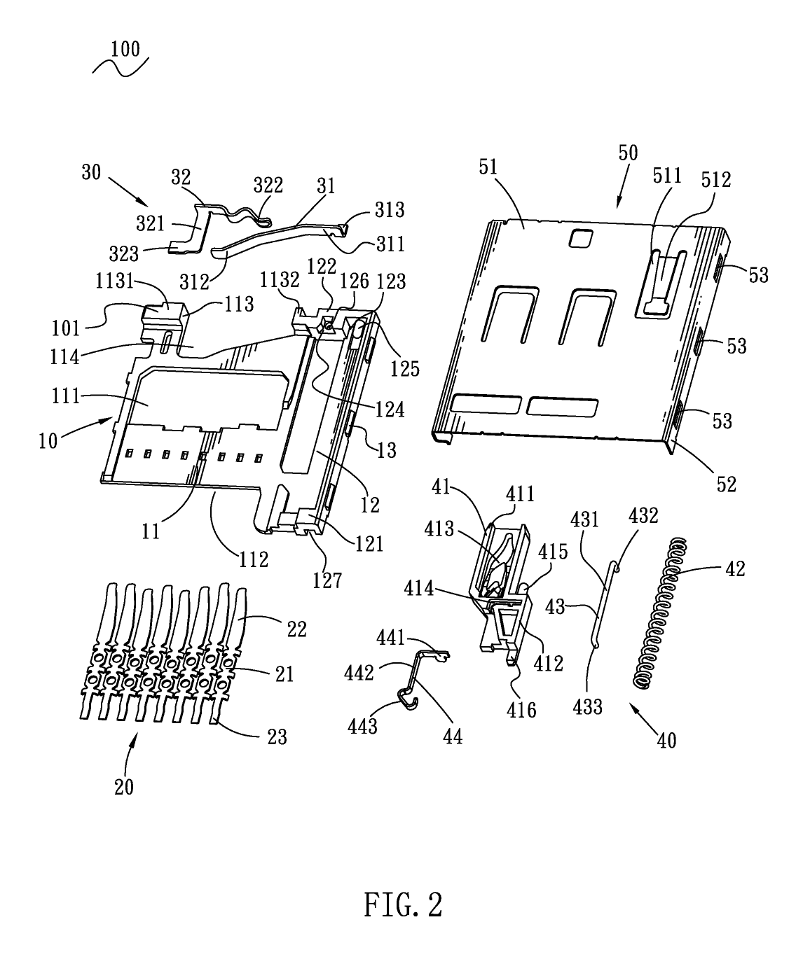

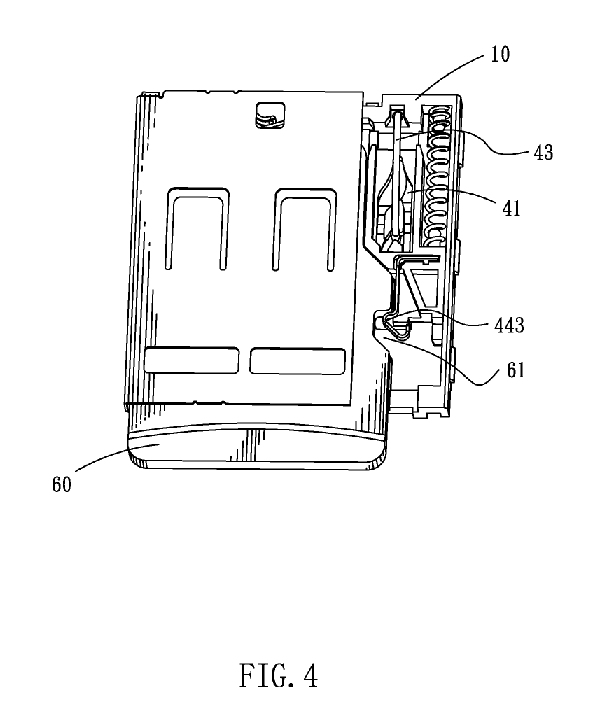

Referring to FIG. 1 and FIG. 2, a card connector 100 in accordance with the present invention is shown. The card connector 100 includes a substantial rectangular insulating housing 10, a plurality of conductive terminals 20, a monitoring assembly 30 and an ejection mechanism 40 held in the insulating housing 10 respectively, and a shield 50 coupled with the insulating housing 10. Herein, supposing a card 60 (shown in FIG. 4) is inserted into the card connector 100 along a front and rear inserting direction, for clear description.

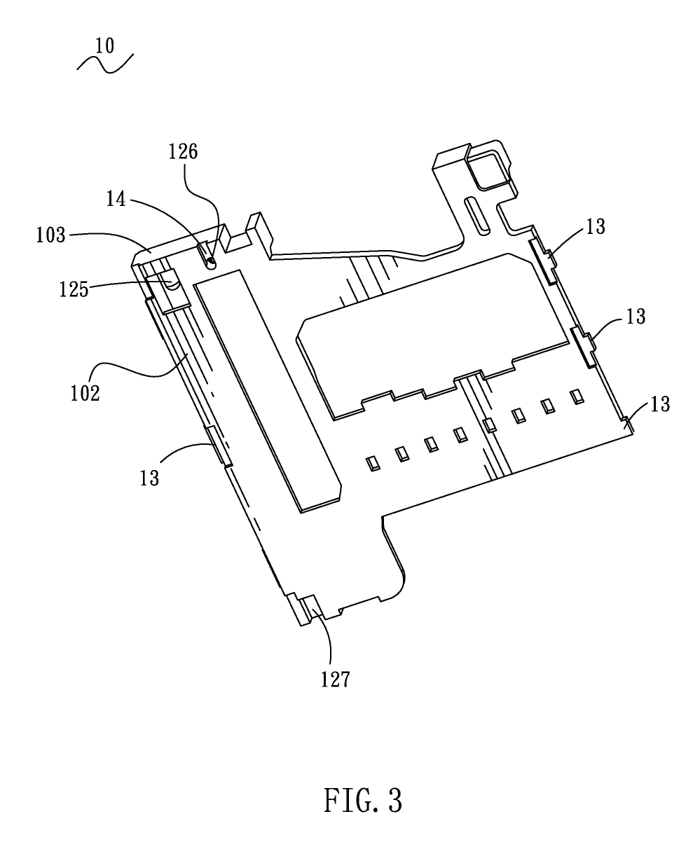

Referring to FIG. 2 and FIG. 3, the insulating housing 10 defines a top 101, a bottom 102 opposite to the top 101 and a rear surface 103 contiguous to the top 101 and the bottom 102. The top 101 has a receiving space 11 reaching a front end of the insulating housing 10 for receiving the card 60 therein and a sliding groove 12 locating alongside of the receiving space 11 and communicating with the receiving space 11. A bottom of the receiving space 11 has a substantial middle portion extended downwards to form a through-hole 111 penetrating the bottom 102 of the insulating housing 10, and a depression 112 formed at a front end thereof apart from the through-hole 111. The sliding groove 12 has a front wall 121 and a rear wall 122 opposite to the front wall 121. A top surface of the rear wall 122 has a rectangular positioning recess 123 and a substantial dovetail groove 124 spaced from the positioning recess 123, and both reaching an inner surface of the rear wall 122. A portion of an inmost side of the positioning recess 123 is extended towards the front wall 121 to form a positioning post 125. The dovetail groove 124 is located nearer to the receiving space 11 than the positioning recess 123 and formed with a receiving hole 126 at a bottom thereof. The front wall 121 has an inserting recess 127 passing therethrough and in alignment with the positioning post 125. The receiving space 11 defines a preventing wall 113 in alignment and connected with the rear wall 122 of the sliding groove 12. The preventing wall 113 has a notch 114 adjacent to the rear wall 122, dividing the preventing wall 113 into a first and second part, designated 1131, and 1132 respectively. The bottom 102 has an observation slot 14 passing through the rear surface 103 of the insulating housing 10, which is located under the receiving hole 126, communicating with the receiving hole 126. Two opposite sides of the insulating housing 10 have the portions protruded laterally to form a plurality of locking lumps 13.

Referring to FIG. 2, each of the conductive terminals 20 has a fixing portion 21. The fixing portion 21 has a rear end extended rearwards and obliquely upwards to form a contacting portion 22. A front end of the fixing portion 21 is extended downwards and oppositely to the fixing portion 21 to form a soldering portion 23. The fixing portions 21 are integrally molded in the insulating housing 10. The contacting portions 22 extend into the receiving space 11 and are located above the through-hole 111 for receiving the pressed contacting portions 22 for reducing the deformation. The soldering portions 23 are arranged in the depression 112 side by side for being soldered on a printed circuit board (PCB, not shown).

The monitoring assembly 30 includes a first monitoring member 31 and a second monitoring member 32. The first monitoring member 31 has a first fixing strip 311 molded in the second part 1132 of the preventing wall 113, a first contacting portion 312 connected with one end of the first fixing strip 311 and projecting into the receiving space 11, and a first soldering strip 313 extended rearwards from a bottom edge of the other end of the first fixing strip 311 exposing outside the insulating housing 10 for being soldered. The second monitoring member 32 has a second fixing strip 321 molded in the first part 1131 of the preventing wall 113. A second contacting portion 322 and a second soldering strip 323 are connected with two opposite ends of the second fixing strip 321 respectively, with oriented ends thereof pointing oppositely to each other. The second contacting portion 322 is a substantial snake shape and disposed rearward of the first contacting portion 312, facing to the first contacting portion 312, with a gap left therebetween. The first contacting portion 312 can be pressed by the inserted card 60 to abut against the second contacting portion 322 to monitor whether the card 60 is fully inserted in the card connector 100.

Referring to FIG. 2 and FIG. 4, the ejection mechanism 40 of a push-push type is disposed at the sliding groove 12 of the insulating housing 10 for ejecting the card 60 from the insulating housing 10 and includes a slider 41, an elastic element 42, a cam lever 43 and a lock member 44. The slider 41 is mounted in the insulating housing along an insertion direction and an ejection direction opposite to the insertion direction and has a first body 411 and a second body 412 connected with a front end of the first body 411 and biased from the first body 411. The first body 411 defines a trace trough 413 at a top surface thereof. The second body 412 has a retraining slot 414 at a portion of a top surface thereof adjacent to the first body 411. The retraining slot 414 extends along a direction substantially perpendicular to the inserting direction of the inserted card 60. A rear end of the second body 412 is protruded rearwards to form a positioning pillar 415 corresponding to the positioning post 125. A front end of the second body 412 is extended frontward to form an inserting portion 416 for engaging in the inserting recess 127 when the card 60 is ejected from the insulating housing 10. Two opposite ends of the elastic element 42 are disposed on the positioning post 125 and the positioning pillar 415 respectively, for providing a push force to the slider 41 along the ejection direction. The cam lever 43 has a connecting portion 431. A rear end and a front end of the connecting portion 431 are bent and extended downwardly to form a first hook portion 432 and a second hook portion 433 shorter than the first hook portion 432 in length, respectively. A height of the receiving hole 126 of the insulating housing 10 is defined between the lengths of the first hook portion 432 and the second hook portion 433. The first hook portion 432 is pivotally received in the receiving hole 126 and projecting into the observation slot 14 under the receiving hole 126. The second hook portion 433 is arranged in the trace trough 413 and moving along the trace trough 413. The lock member 44 has a retention arm 442 and a holding arm 441 extended perpendicularly from one free end of the retention arm 442 to show an L shape and restrained in the retraining slot 414 of the slider 41. The other end of the retention arm 442 is arched to form a V-shaped hook 443, with a point thereof pointing towards a direction opposite to the holding arm 441, for inserting into a gap 61 of the card 60 to prevent the card 60 from breaking off the card connector 100 suddenly in withdrawal of the card 60.

The shield 50 has a rectangular base plate 51. Two opposite sides of the base plate 51 extend downward to form two lateral plates 52. Each of the lateral plates 52 is punched with a plurality of locking holes 53 buckled with the respective locking lumps 13 of the insulating housing 10 for fixing the shield 50 to the insulating housing 10. A top of the base plate 51 has a substantial rectangular opening 511. A rear side of the opening 511 extends downwards and frontward to form a flexible resisting arm 512 capable of abutting on the cam lever 43 of the ejection mechanism 40, which makes the cam lever 43 stably move in the trace trough 413 of the slider 41.

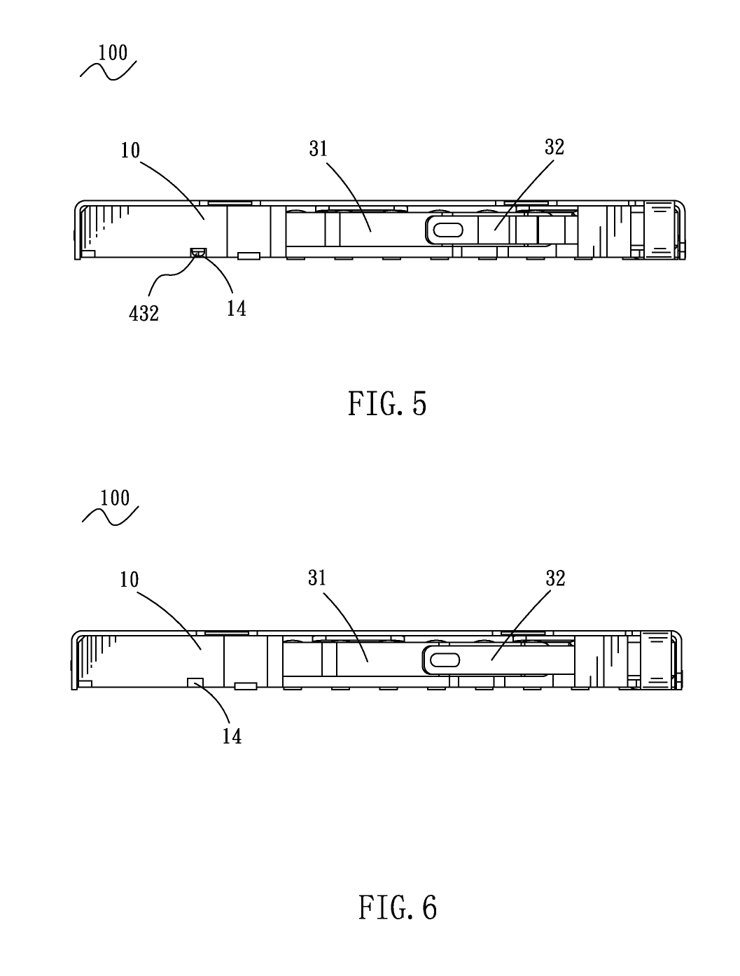

Referring to FIG. 5 and FIG. 6, when the cam lever 43 of the ejection mechanism 40 is correctly assembled to the slider 41, the shorter second hook portion 433 is received in the trace trough 413, the longer first hook portion 432 is inserted into the receiving hole 126 and a free end thereof stretches into the observation slot 14 with a predetermined distance for being observed by a charge coupled device (not shown) which can enlarge the image of the observation slot 14. When the cam lever 43 is assembled with an incorrect inserting direction, a free of the shorter second hook portion 433 is entirely received in the receiving hole 126 and not exposed in the observation slot 14, which can not be observed by the charge coupled device. Whereby, in assembly of the cam lever 43, which of the first and second hook portions 432, 433 being inserted in the receiving hole 126 can be recognized by observing if the free ends of the first and second hook portions 432, 433 are extended into the observation slot 14.

As described above, whether the free ends of the first hook portion 432 and the second hook portion 433 being extended into the observation slot 14 can be observed to check the inserting direction of the cam lever 43, which ensures the cam lever 43 to be correctly assembled to the slider 41 of the ejection mechanism 40 and saves the assembly time. So the card connector 100 is excellent and can be used widely, and for a long time.

Furthermore, the present invention is not limited to the embodiment described above; various additions, alterations and the like may be made within the scope of the present invention by a person skilled in the art. For example, respective embodiments may be appropriately combined.

What is claimed is:

1. A card connector adapted for receiving a card therein, comprising:
an insulating housing defining a top, a bottom opposite to the top, the top having a receiving space for receiving the inserted card;
a plurality of conductive terminals disposed in the insulating housing for contacting the card; and
an ejection mechanism of a push-push type disposed at one side of the insulating housing for ejecting the card from the insulating housing, the ejection mechanism comprising a slider slidably mounted in the insulating housing along an insertion direction and an ejection direction opposite to the insertion direction, an elastic element for providing a push force to the slider along the ejection direction and a cam lever, two opposite ends of the cam lever respectively being bent towards a same side to form a first hook portion for being fixed in a receiving hole defined at a top of the insulating housing and a second hook portion for being movably arranged in the slider and different in length with the first hook portion,
wherein the bottom of the insulating housing defines an observation slot communicating with the receiving hole at a portion corresponding to the receiving hole, the height of the receiving hole is shorter than the length of one of the first and second hook portions and not shorter than the other of the first and second hook portions, whereby, in assembly of the cam lever, which of the first and second hook portion being inserted in the receiving hole can be recognized by observing if free ends of the first and second hook portions are extended into the observation slot.

2. The card connector as claimed in claim 1, wherein the length of the first hook portion is longer than that of the second hook portion.

3. The card connector as claimed in claim 1, wherein the top of the insulating housing has a sliding groove arranged at one side of the receiving space and communicating with the receiving space, the slider of the ejection mechanism is slidably disposed in the sliding groove.

4. The card connector as claimed in claim 3, wherein the sliding groove has a rear wall, the rear wall has a positioning post protruded frontward, the slider is formed with a positioning pillar corresponding to the positioning post and a trace trough for receiving the second hook portion of the cam lever, two opposite ends of the elastic element are disposed on the positioning post and the positioning pillar respectively.

5. The card connector as claimed in claim 1, wherein the observation slot extends along the insertion and ejection direction to penetrate an adjacent end of the insulating housing for convenience of observation.
